(19) United States
(12) Patent Application Publication
(10) Pub. No.: US 2017/0238159 A1
(43) Pub. Date: Aug. 17, 2017

(54) METHOD AND APPARATUS FOR HANDLING OF MEDIA-BASED ROUTING

(71) Applicant: NOKIA SOLUTIONS AND NETWORKS OY, Espoo (FI)

(72) Inventors: Nagaraja RAO, Boca Raton, FL (US); Peter LEIS, Penzberg (DE)

(73) Assignee: NOKIA SOLUTIONS AND NETWORKS OY, Espoo (FI)

(21) Appl. No.: 15/503,139

(22) PCT Filed: Aug. 11, 2014
(86) PCT No.: PCT/EP2014/067154

§ 371 Date: Feb. 10, 2017

(51) Int. Cl. H04W 4/22; H04M 7/00; H04M 3/51; H04W 40/20; H04L 29/06

(52) U.S. Cl. CPC H04W 4/22; H04W 40/20; H04L 65/1006; H04L 65/105; H04L 65/1016; H04M 3/5116; H04M 7/0051

(57) ABSTRACT

Abstract: A method and apparatus can be configured to receive a first session-initiation-protocol (SIP) message relating to an attempt to make a call. The method may include determining that the attempt to make the call is an attempt to make a multime-dia-messaging-emergency-services call. The method may include transmitting an indication of the attempt to make the multimedia-messaging-emergency-services call. The indication is transmitted to a second node. The method may also include transmitting a second session-initiation-protocol message relating to a denial of serving the multimedia-messaging-emergency-services call.

### BACKGROUND

Field

Embodiments of the invention relate to handling of media-based routing.

Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may include receiving, by a first network node, a first session-initiation-protocol message relating to an attempt to make a call. The method may also include determining that the attempt to make the call is an attempt to make a multimedia-messaging-emergency-services call. The method may also include transmitting an indication of the attempt to make the multimedia-messaging-emergency-services call, wherein the indication is transmitted to a second node. The method may also include transmitting a second session-initiation-protocol message relating to a denial of serving the multimedia-messaging-emergency-services call.

In the method of the first embodiment, the first network node may comprise a location-retrieval-function, and the second node may comprise a route-determination-function.

In the method of the first embodiment, the first network node may comprise an emergency-services-routing-proxy, and the second node may comprise an emergency-call-routing-function.

In the method of the first embodiment, the determining that the attempt to make the call is an attempt to make a multimedia-messaging-emergency-services call may be based on a media type that is used by the call, and the media type that is used by the call may be different than voice and/or text media.

In the method of the first embodiment, the first session-initiation-protocol message may comprise a SIP INVITE message, and the second session-initiation-protocol message may comprise an SIP 488 Not Acceptable Here message.

In the method of the first embodiment, the transmitting the indication of the attempt may comprise transmitting the indication via a LoST:findService message.

According to a second embodiment, an apparatus may include receiving means for receiving a first session-initiation-protocol message relating to an attempt to make a call. The apparatus may also include determining means for determining that the attempt to make the call is an attempt to make a multimedia-messaging-emergency-services call. The apparatus may also include first transmitting means for transmitting an indication of the attempt to make the multimedia-messaging-emergency-services call, wherein the indication is transmitted to a first node. The apparatus may also include second transmitting means for transmitting a second session-initiation-protocol message relating to a denial of serving the multimedia-messaging-emergency-services call.

In the apparatus of the second embodiment, the apparatus may comprise a location-retrieval-function, and the first node may comprise a route-determination-function.

In the apparatus of the second embodiment, the apparatus may comprise an emergency-services-routing-proxy, and the first node may comprise an emergency-call-routing-function.

In the apparatus of the second embodiment, the determining that the attempt to make the call is an attempt to make a multimedia-messaging-emergency-services call is based on a media type that is used by the call, and the media type that is used by the call is different than voice and/or text media.

In the apparatus of the second embodiment, the first session-initiation-protocol message may comprise a SIP INVITE message, and the second session-initiation-protocol message may comprise an SIP 488 Not Acceptable Here message.

In the apparatus of the second embodiment, the transmitting the indication of the attempt may comprise transmitting the indication via a LoST:findService message.

According to a third embodiment, a computer program product may be embodied on a non-transitory computer readable medium. The computer program product may be configured to control a processor to perform a process according to a method of the first embodiment.

According to a fourth embodiment, a method may include receiving, by a network node, an indication of an attempt to make a multimedia-messaging-emergency-services call. The method may also include selecting a route that would redirect the multimedia-messaging-emergency-services call.

In the method of the fourth embodiment, the network node may comprise a routing-determination-function.

In the method of the fourth embodiment, the network node may comprise an emergency-call-routing-function.

In the method of the fourth embodiment, the selecting the route may comprise selecting an alternate emergency-services route uniform-resource-identifier.

In the method of the fourth embodiment, the selecting the route may comprise selecting a route that redirects the multimedia-message-emergency-services call away from a legacy public-safety-answering point.

In the method of the fourth embodiment, the selecting the route may comprise selecting a route that takes the multimedia-message-emergency-services call to an emergency-services-ip-network.

According to a fifth embodiment, an apparatus may include receiving means for receiving an indication of an attempt to make a multimedia-messaging-emergency-services call. The apparatus may also include selecting means for selecting a route that would redirect the multimedia-messaging-emergency-services call.

In the apparatus of the fifth embodiment, the apparatus may comprise a routing-determination-function.

In the apparatus of the fifth embodiment, the apparatus may comprise an emergency-call-routing-function.

In the apparatus of the fifth embodiment, the selecting the route may comprise selecting an alternate emergency-services route uniform-resource-identifier.

In the apparatus of the fifth embodiment, the selecting the route may comprise selecting a route that redirects the multimedia-message-emergency-services call away from a legacy public-safety-answering point.

In the apparatus of the fifth embodiment, the selecting the route may comprise selecting a route that takes the multimedia-message-emergency-services call to an emergency-services-ip-network.

According to a sixth embodiment, a computer program product may be embodied on a non-transitory computer readable medium. The computer program product may be configured to control a processor to perform a process according to a method of any of the fourth embodiment.

### BRIEF DESCRIPTION OF THE DRAWINGS:

For proper understanding of the invention, reference should be made to the accompanying drawings, wherein:

FIG. 1 illustrates an emergency call-handling architecture.

FIG. 2 illustrates Location-Routing-Function/Routing-Determination-Function (LRF/RDF) logic for determining the Emergency Services (ES) Routing Information.

FIG. 3 illustrates an emergency call to a legacy PSAP via a legacy selective router (SR).

FIG. 4 illustrates Emergency-Services-IP-Network Logic used to determine the Public-Safety-Answering-Point (PSAP).

FIG. 5 illustrates an emergency call that is routed to an NG9-1-1 PSAP.

FIG. 6 illustrates routing an emergency call to a legacy PSAP via ESInet.

FIG. 7 illustrates routing an MMES Call to an NG9-1-1 PSAP.

FIG. 8 illustrates a flow diagram relating to a new INVITE.

FIG. 9 illustrates how an MGCF may send a Session-Description-Protocol answer.

FIG. 10 illustrates a flow diagram where a caller, who initiates a voice emergency call, upgrades the call to an MMES call.

FIG. 11 illustrates enhancements to LRF/RDF functions.

FIG. 12 illustrates enhancements to ESRP/ECRF functions.

FIG. 13 illustrates a flow diagram that shows an MMES call origination attempt when the intended PSAP is to be via a Legacy SR, and the desired media is different from Audio or Text.

FIG. 14 illustrates a flow diagram that shows an MMES call origination attempt when the intended PSAP is a Legacy PSAP to be reached via ESInet, and the desired media is different from Audio or Text.

FIG. 15 illustrates originating an MMES call with NG9-1-1 as a destination PSAP.

FIG. 16 illustrates a flow diagram that shows the MMES call origination attempt when the intended PSAP is served via Legacy SR and the desired media includes Audio.

FIG. 17 illustrates a flow diagram that shows the MMES call origination attempt when the intended PSAP is served via Legacy PSAP via ESInet, and the desired media may include Audio.

FIG. 18 illustrates an alternative implementation in accordance with one embodiment.

FIG. 19 illustrates an embodiment of the present invention.

FIG. 20 illustrates another embodiment of the present invention.

FIG. 21 illustrates an MMES Call Attempt to Legacy PSAP via ESINET.

FIG. 22 illustrates a logic flow diagram of a method according to certain embodiments of the invention.

FIG. 23 illustrates a logic flow diagram of a method according to certain embodiments of the invention.

FIG. 24 illustrates an apparatus in accordance with one embodiment.

FIG. 25 illustrates an apparatus in accordance with one embodiment.

FIG. 26 illustrates an apparatus according to embodiments of the invention.

### DETAILED DESCRIPTION:

Embodiments of the invention relate to handling of media-based routing. For example, embodiments of the invention may relate to handling of media-based routing in Multimedia Emergency Services (MMES).

When using Multimedia Emergency Services (MMES), an emergency call originator initiates a multimedia call. Until now, the emergency calls were limited to voice and global text telephony (GTT). 3GPP has defined stage 1 requirements to support emergency calls involving other types of media (media types such as, for example, video and instant messaging). The Alliance for Telecommunications Industry Solutions (ATIS) has a new project directed to developing standards on MMES.

An emergency call which uses media different from voice or GTT cannot be routed to legacy public-safety answering points (PSAPs). Such an emergency call cannot be routed to legacy PSAPs because the other media (such as video) may require higher bandwidth, and calls to legacy PSAPs can only be routed using circuit-switched (CS) trunks. In other words, some of the multimedia emergency calls can only be routed to next generation PSAPs (also known as NG9-1-1 PSAP). A mechanism for incorporating the other media (such as video) into routing policies has yet to be defined in the current standards.

The PSAP, to which an emergency call is routed to, is generally determined based on a caller's location. Currently, the caller's location is used to determine the PSAP that has to serve the call. An operator's location-based routing database has a PSAP that is pre-determined for every possible location of the caller. With voice or GTT calls, the performing of such location-based routing is not necessary because, as described above, all PSAPs can receive voice or GTT calls. In other words, with the current call-handling logic, an emergency call can generally be routed to any PSAP as all PSAPs are able to handle voice and GTT calls. If a PSAP that is dedicated to serving the caller's location is out of service or not available for some other reason, the call routing logic may find an alternate PSAP that serves the nearby location. There is generally no scenario where a voice or GTT call is denied.

However, a call that is a multimedia emergency call may be denied. As described earlier, a MMES call for media types which are different than voice and GTT can generally only be completed by an NG9-1-1 PSAP. Therefore, if (1) the caller initiates an MMES call that is different than voice and GTT, and (2) an operator's location-based routing database directs the call to a legacy PSAP, then such an emergency call generally cannot be completed with the media type desired by the caller. Further, an alternate PSAP with the required media types may possibly not be available to serve the location.

On the other hand, if an alternate PSAP with the required media types is available, the current emergency routing logic may not be able to select that alternate PSAP because the process of determining the PSAP (for which the call is routed to) does not take into account the media type that is desired by the caller. As described above, the current process of determining the PSAP is based merely on location. If a legacy PSAP is the only choice for which the call is routed to, then the emergency call with the desired media type (of multimedia) cannot be completed. Because the caller has no prior knowledge of the nature of the PSAP call taker, the caller may decide to initiate a MMES call, regardless of the location from where the call is initiated.

One option for completing a multimedia-type call with a legacy PSAP may be to automatically downgrade the multimedia emergency call to a voice or a GTT call. The automatic downgrade may be network-initiated. However, performing such an automatic downgrade may not be possible. For example, the automatic downgrade may not be possible if the call does not include voice or GTT as one of the desired media types to be utilized by the call. Furthermore, downgrading the multimedia emergency call without a caller's consent may result in confusion for the caller.

Additionally, because additional network nodes are often involved in the handling of an emergency call, care should be taken to avoid introducing unnecessary delay to the call setup.

In summary, with MMES, there exists a need for a method to gracefully deny or to downgrade a call (to downgrade a multimedia-type call, for example) to a voice or GTT call without adding any unnecessary call setup delay. There exists a need to deny or downgrade the call without creating any confusion for the caller.

In view of the above difficulties, certain embodiments of the present invention may downgrade the call by seeking caller consent before performing any action in changing the media type of the call. Further, certain embodiments of the present invention may determine a PSAP based on the desired media type of the call. A method that selects an alternate PSAP (if such a PSAP is available) to serve the caller's location, based on the desired media type, will increase the possibility successfully completing an MMES call attempt.

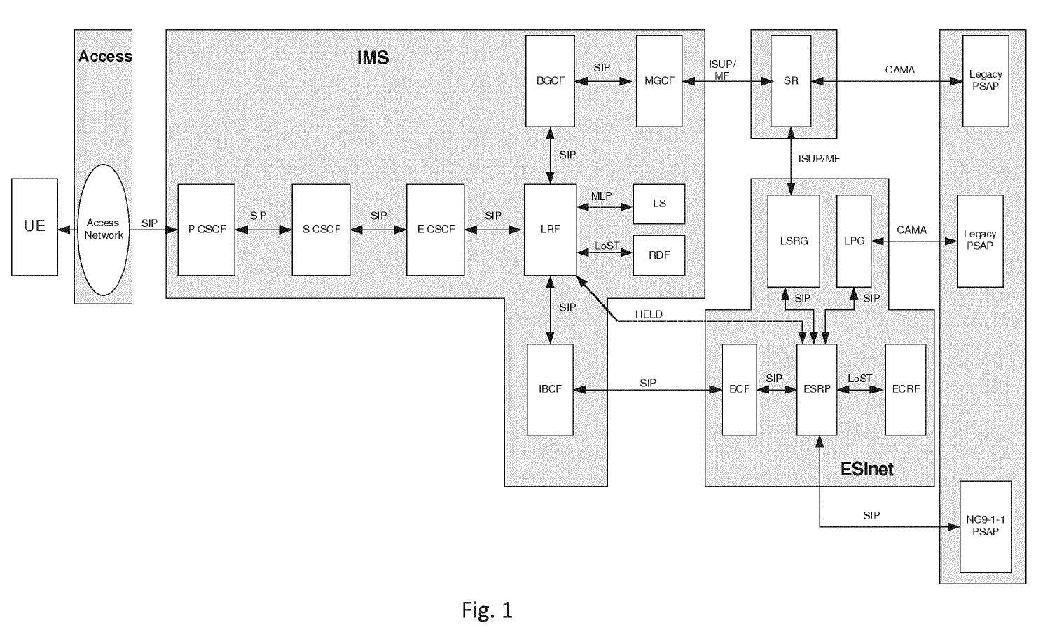

FIG. 1 illustrates an emergency call-handling architecture. This architecture may be applicable to MMES. A Session-Initiation-Protocol (SIP) INVITE message may originate from a caller's user equipment (UE). The SIP INVITE message is routed to the LRF (Location Routing Function). The LRF may determine Emergency Services (ES) Routing Information based on the caller's location. The LRF interacts with a Routing-Determination-Function (RDF) to acquire the emergency call routing information. The LRF also interacts with the Location Server (LS) to acquire the location of the UE.

The LRF then returns the ES Routing Information within the Contact header of an SIP: 3XX message (such as an SIP: 300 Multiple Choices message, for example) to the E-CSCF. Based on the ES Routing Information, the emergency call may be routed to a Legacy PSAP (via a Selective Router (SR), also known as a Legacy SR) or to the ESInet. From the ESInet, the emergency call may be routed to a NG9-1-1 PSAP or to a Legacy PSAP (via Legacy PSAP Gateway (LPG) or Legacy Selective Router Gateway (LSRG)).

In the architecture of FIG. 1, an SIP 300 Multiple Choices message is sent by the LRF to the E-CSCF. Also, the E-CSCF routes the call towards the appropriate PSAP. Upon receiving the SIP INVITE, the LRF determines the ES Routing Information based on the caller's location information. To perform this determination, the LRF interacts with the RDF. The ES Routing Information may direct the call to a Legacy PSAP (via Legacy SR) or to an ESInet.

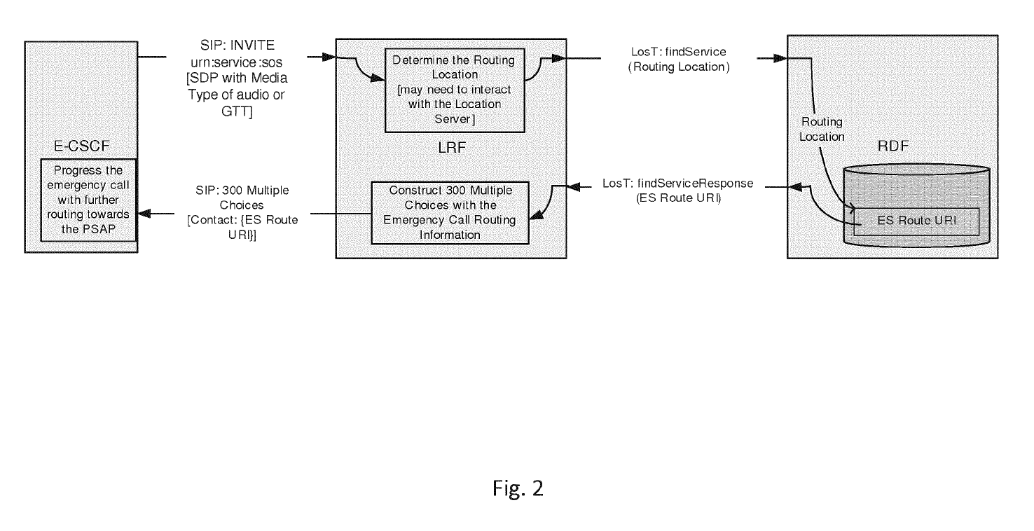

FIG. 2 illustrates Location-Routing-Function/Routing-Determination-Function (LRF/RDF) logic for determining the Emergency Services (ES) Routing Information. FIG. 2 illustrates an overview of the LRF/RDF process.

An ES Route Uniform-Resource-Identifier (URI) (basically, the ES Routing Information) is returned to the Emergency CSCF (E-CSCF) in the SIP 300 Multiple Choices message. Based on the format of the ES Route URI (a TEL URI versus an SIP URI), the E-CSCF is able to determine whether the designated PSAP is to be reached via the Legacy SR or via the ESInet. In the former case, the E-CSCF puts the ES Route URI into the Request URI of the SIP INVITE and forwards the SIP INVITE towards the Legacy SR (via a Breakout-Gateway-Control-Function/Media-Gateway-Control-Function (BGCF/MGCF)).

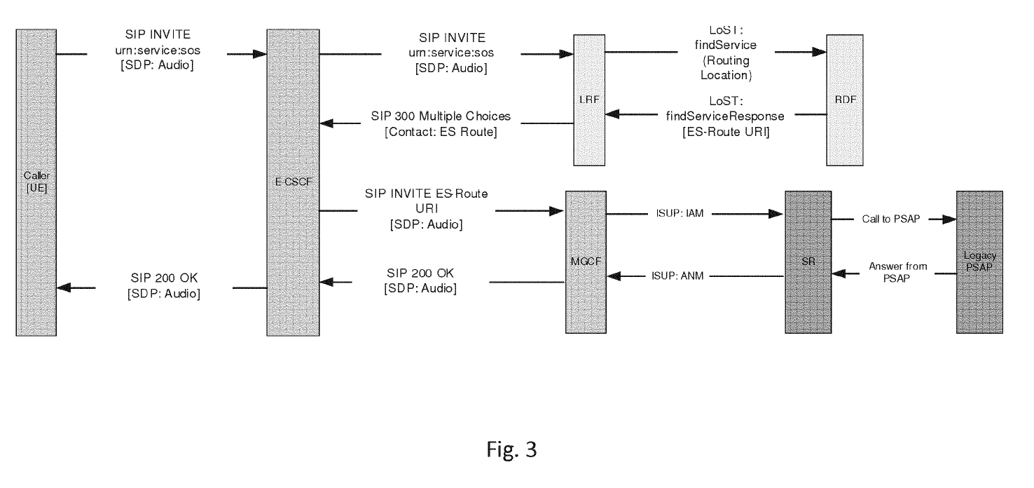

FIG. 3 illustrates an emergency call to a legacy PSAP via a legacy selective router (SR). FIG. 3 illustrates an example flow diagram for media-type audio (i.e., voice). FIG. 3 does not illustrate all possible SIP messages. Also, FIG. 3 does not illustrate all possible network nodes.

When the designated PSAP has to be reached via ESInet, the Emergency-CSCF (E-CSCF) places the ES Route URI into the Route header and routes the call towards the ESInet via the Interconnect Border-Control-Function (IBCF).

Emergency Services IP Network (ESInet) determines the actual PSAP that serves the routing location and routes the call to that PSAP. The PSAP can be a NG9-1-1 PSAP or a Legacy PSAP. The calls to the Legacy PSAP are routed via a Legacy PSAP Gateway (LPG) or a Legacy-Selective-Router Gateway (LSRG).

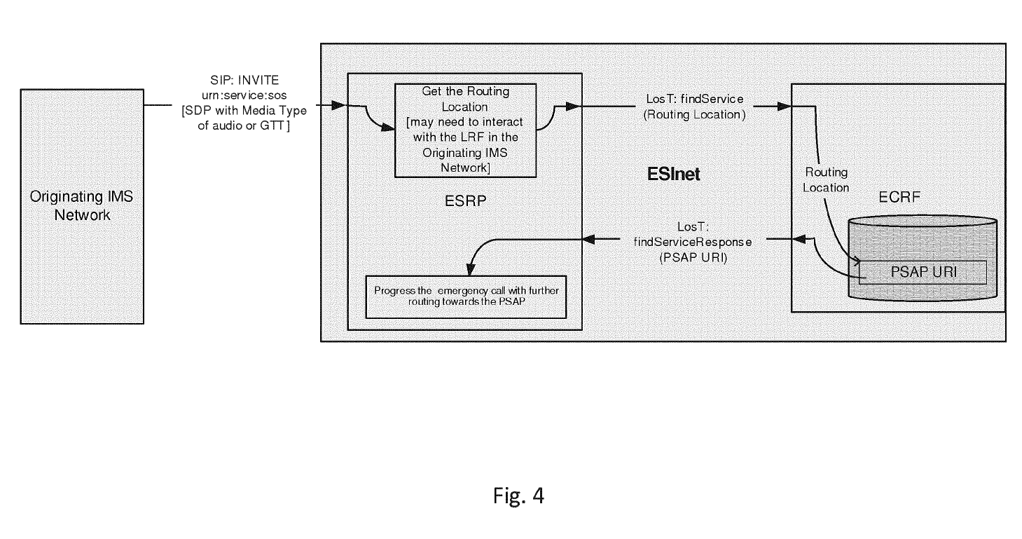

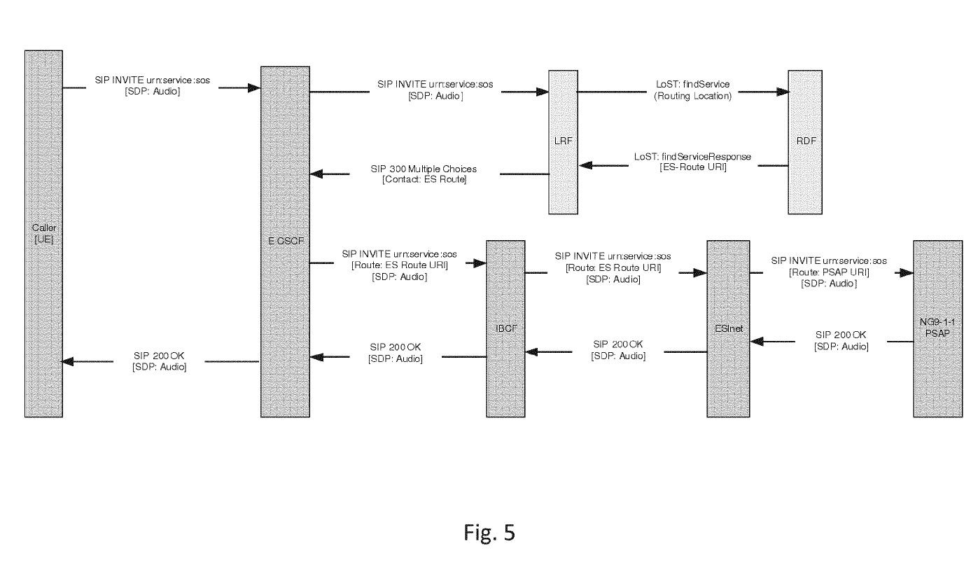

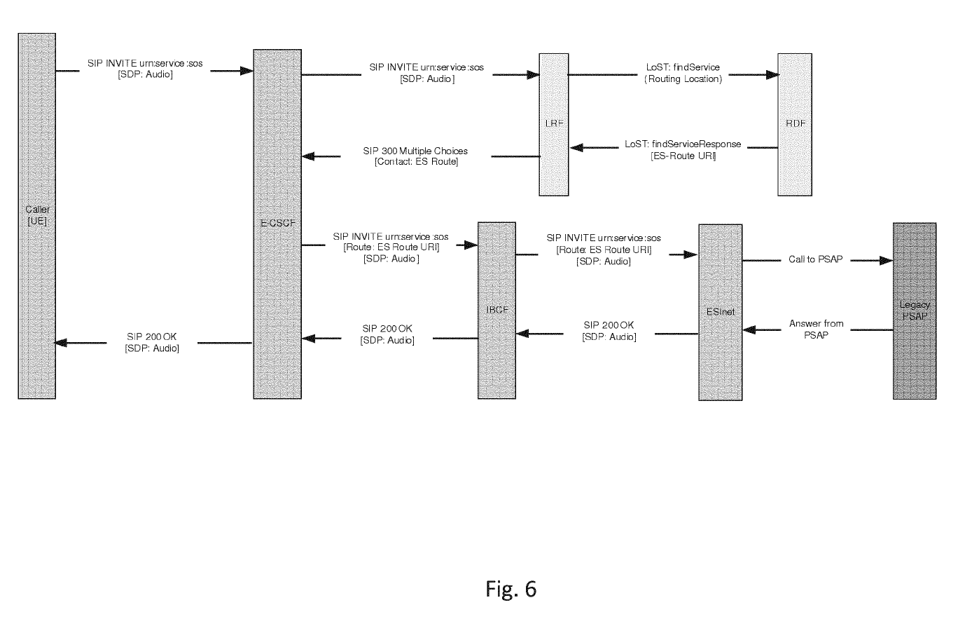

FIG. 4 illustrates Emergency-Services-IP-Network Logic used to determine the Public-Safety-Answering-Point (PSAP). Depending on the call scenario, the Emergency-Services-Routing-Proxy (ESRP) may have to interact with the LRF to acquire the routing location. The ESRP interacts with the Emergency-Call-Routing-Function (ECRF) to determine the PSAP routing information (shown as PSAP URI in FIG. 4). FIG. 5 and FIG. 6 illustrate the flow diagrams for emergency calls routed via the ESInet. FIG. 5 illustrates an emergency call that is routed to an NG9-1-1 PSAP. FIG. 6 illustrates routing an emergency call to a legacy PSAP via ESInet.

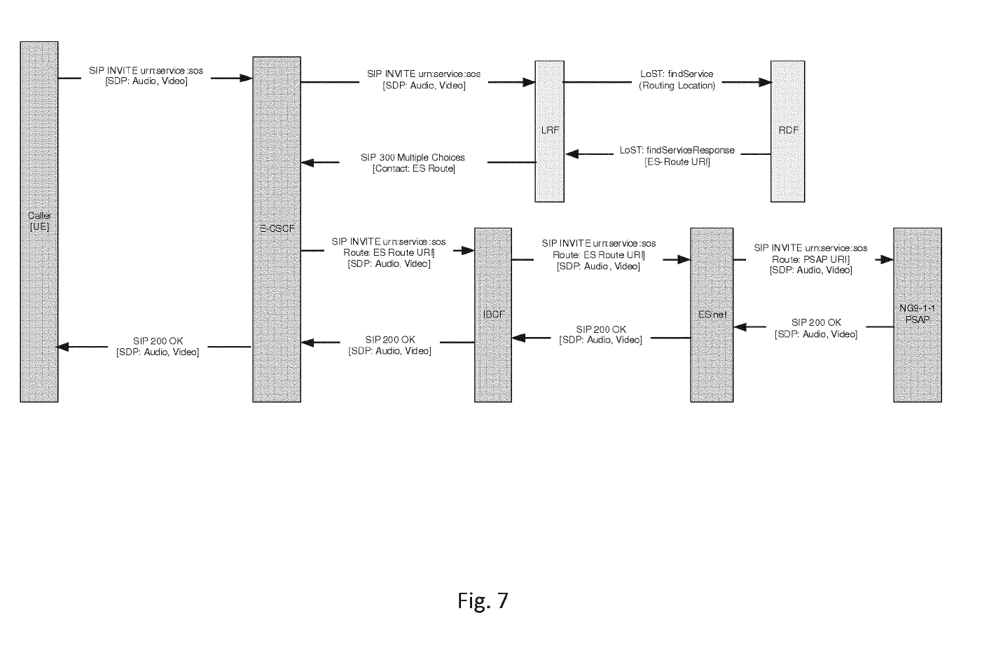

FIG. 7 illustrates routing an MMES Call to an NG9-1-1 PSAP. The call flow diagram of FIG. 7 routes an MMES call. The MMES call can use audio or video media types. FIG. 7 does not show all possible SIP messages involved in the call. Also, not all NG9-1-1 PSAP necessarily support MMES calls.

The example shown in FIG. 7 is one way to perform MMES call handling. However, as described above, a caller may not necessarily know whether the caller's emergency call will served by an NG9-1-1 PSAP or by a Legacy PSAP. When the caller originates an MMES call, and if the intended PSAP is a legacy PSAP, then completing the call with the desired MMES media type may not be possible.

When the caller originates an MMES call that does not include any media type supported by the Legacy PSAP (i.e., a media type that is different from voice/GTT), the MGCF is expected to reject the call with an SIP 488 “Not Acceptable Here” message. According 3GPP TS 24.229, the UE is expected to send a new INVITE with the supported media types.

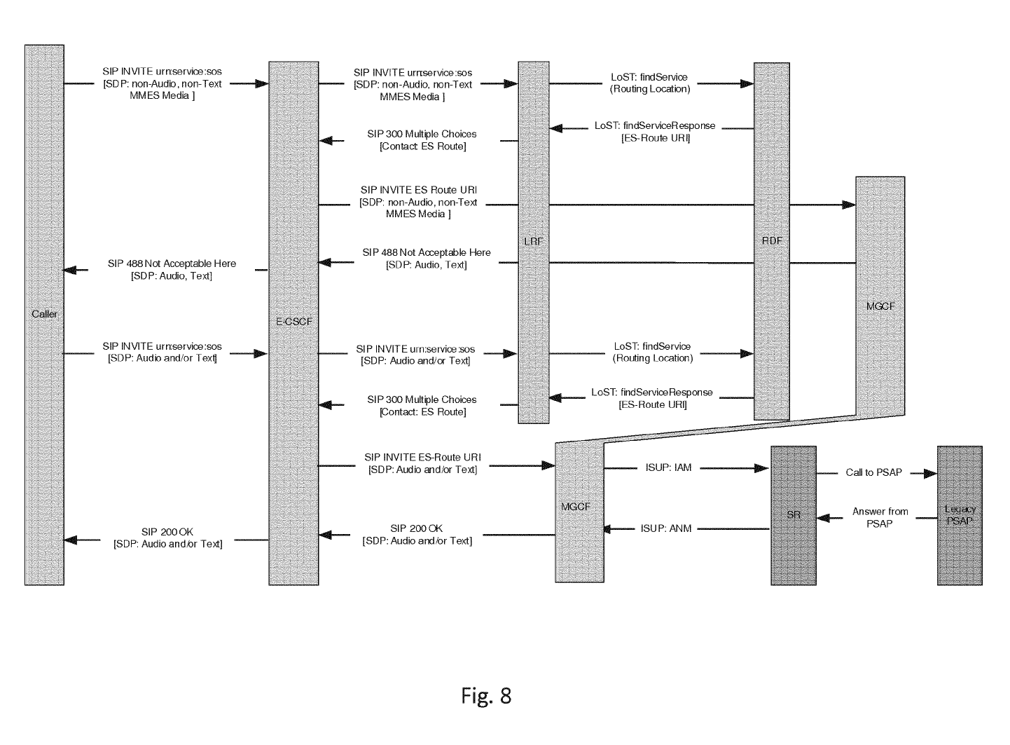

FIG. 8 illustrates a flow diagram relating to a new INVITE. FIG. 8 does not show all the possible SIP messages that may be involved in the call. Also, an emergency call can also reach a Legacy PSAP via the ESInet. In this case, the node (i.e., an LPG or an LSRG) that serves the Legacy PSAP will handle the call in the same manner as the MGCF of FIG. 8.

If the MMES call includes either Voice or GTT (both of which are supported by Legacy PSAP), then the MGCF could send a Session-Description-Protocol (SDP) answer with port=0 for the unsupported media types. In general, when an entity returns an SDP answer to an SDP offer, the entity is supposed to assign a port number for each of the media streams. In the event that the entity does not support a particular media stream, but supports at least one of the media streams of the SDP offer, then the entity could return a value of 0 for the port corresponding to the particular media stream. Since, port=0 is not a valid port number, the entity that receives the SDP answer (i.e., the entity that had sent the SDP offer) understands that the other entity (which sent the SDP answer) does not support that particular media type. The entity that receives the SDP answer would then utilize the other media types for which this entity did receive a non-zero value for the corresponding port. If the entity that receives the SDP offer supports none of the media types, then this entity is supposed to send back an SIP:488 message.

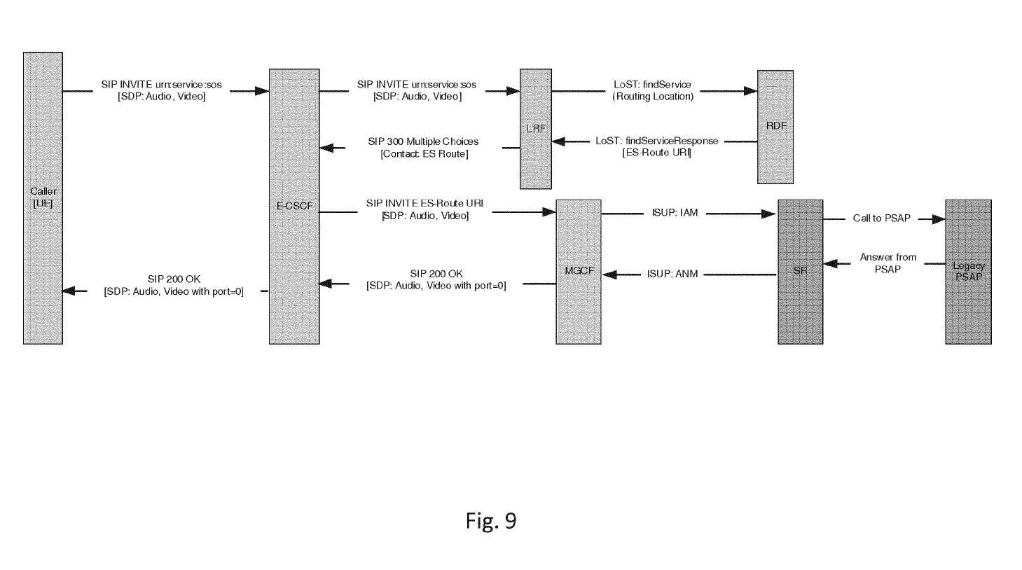

FIG. 9 illustrates how an MGCF may send a Session-Description-Protocol answer. FIG. 9 does not show all the possible SIP messages involved in the call. An emergency call can also reach a Legacy PSAP via the ESInet. In this case, the node (i.e., an LPG or an LSRG) that serves the Legacy PSAP will handle the call in the same manner as the MGCF of FIG. 9.

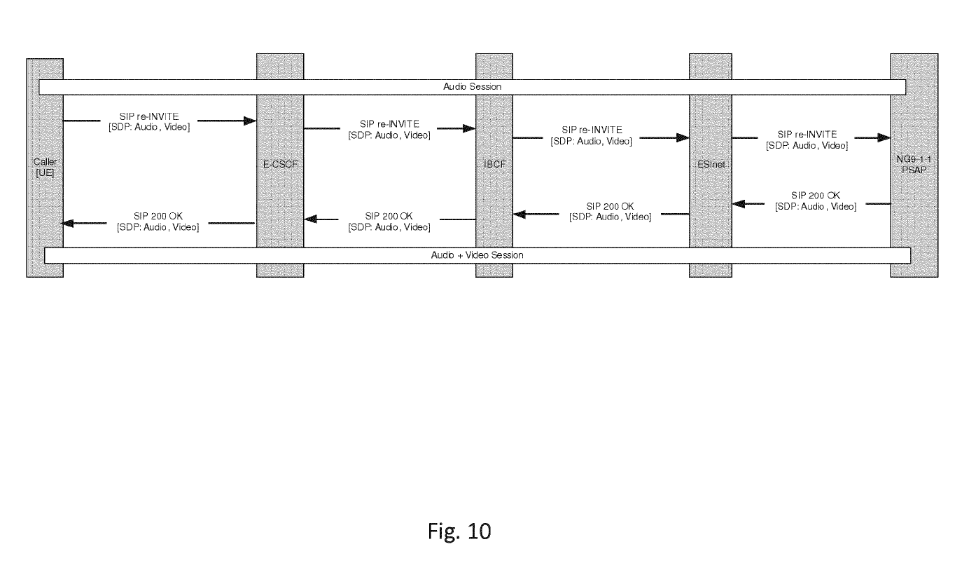

FIG. 10 illustrates a flow diagram where a caller, who initiates a voice emergency call, upgrades the call to an MMES call. For example, the call may be upgraded to an MMES call by adding video. FIG. 10 assumes that the NG9-1-1 PSAP (which serves the caller) is able to support the video.

As described above, with the current logic for emergency-call routing, a PSAP is determined based upon a caller's location. This current logic may not be suitable for MMES because not all PSAPs support the multimedia. For example, Legacy PSAPs do not support any media different than voice or text.

Embodiments of the present invention provide a mechanism to consider a caller's desired media type (along with the caller's location) to determine a PSAP for serving the MMES call. Embodiments of the present invention may provide a mechanism to select an alternate PSAP that supports the desired media. Embodiments of the present invention may use an efficient routing logic to set up the emergency call with the media type that is supported by the serving PSAP.

Embodiments of the present invention provide a mechanism for a system to select an alternate PSAP (such as an NG9-1-1 PSAP), if available, to serve a caller's location (when the caller originates an MMES call and the call is initially designated to be routed to a Legacy PSAP). Embodiments of the present invention provide a mechanism to improve the signalling load (i.e., to result in less signalling) in the handling of an MMES call, when the desired media types are not supported by the PSAP that is chosen to serve the call. In other words, embodiments of the present invention may improve the signalling load (i.e., by reducing a signaling traffic) when the chosen PSAP is a Legacy PSAP for an MMES call. Embodiments of the present invention may be backward compatible.

When using embodiments of the present invention, the MGCF, LPG, and LSRG may provide the functions defined in the existing standards. For example, the MGCF, LPG, and LSRG may satisfy the requirements stated in 3GPP Technical Specification (TS) 29.163, while also dealing with the unsupported media types present in the SDP. Furthermore, with embodiments of the present invention, a UE may operate in accordance with the requirements stated in 3GPP TS 24.229, when an SIP 488 Not Acceptable Here is received.

Embodiments of the present invention may be directed to the functions provided by an E-CSCF, LRF, RDF, ESRP, and ECRF. As described above, in the current emergency call routing logic, the LRF, upon receiving the SIP INVITE, determines the ES Route URI (ES Routing Information). The ES Route URI may be based on the caller's location information as per the current architecture. The LRF may interact with the RDF. The ES Route URI may be used to route the call to a Legacy PSAP (via a Legacy SR) or to an ESInet. When the call is routed to ESInet, an ESRP (inside the ESInet) determines the PSAP that serves the caller's location. For such determining, the ESRP interacts with the ECRF. From ESInet, the call may be routed to either an NG9-1-1 PSAP or a Legacy PSAP.

Certain embodiments of the present invention may provide enhancements to LRF/RDF/E-CSCF functions. Certain embodiments of the present invention may provide a first enhancement to LRF/RDF functions. With this first enhancement, the LRF transmits an MMES call attempt indication to the Routing-Determination-Function (RDF) in a message (such as a Location-to-Service-Translation (LoST): findService message). The LRF transmits the indication for an MMES call attempt if the desired media types indicate an MMES call attempt. Desired media types may be the media types present in the SDP of SIP INVITE received from the E-CSCF.

Certain embodiments of the present invention may provide a second enhancement to LRF/RDF functions. With this second enhancement, the RDF uses the MMES call attempt indication to select an alternate ES Route URI (if available) that would route the MMES call to ESInet. The alternate ES Route URI is selected if the first choice ES Route URI would have taken the call to a Legacy PSAP via a Legacy SR.

Certain embodiments of the present invention may provide a third enhancement to LRF/RDF functions. With this third enhancement, the LRF sends a SIP: 488 Not Acceptable Here (to the E-CSCF) if the desired media type in the SIP INVITE does not have the media types supported by Legacy PSAP (i.e., does not have audio or text), and if the ES Route URI points to a Legacy SR. The SIP 488 Not Acceptable Here message carries the supported SDP information and a warning header with the reason for the denial.

Certain embodiments of the present invention may provide a fourth enhancement to E-CSCF functions. With this fourth embodiment, the E-CSCF may take appropriate action upon receiving the SIP 488 Not Acceptable Here message. With embodiments of the present invention, the E-CSCF may forward the SIP 488 Not Acceptable Here message towards the UE.

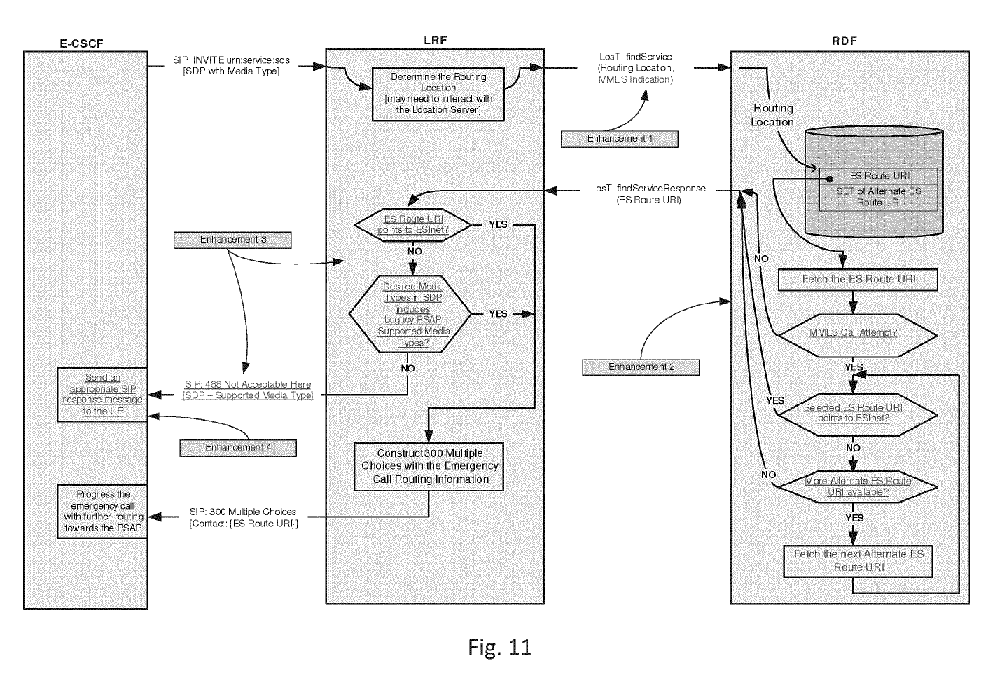

FIG. 11 illustrates enhancements to LRF/RDF functions. The above-described first and second enhancement may be needed if a deployment seeks to select an NG9-1-1 PSAP as an alternate PSAP for serving the caller's location, when the emergency call is an MMES call, and when a first choice PSAP (i.e., the PSAP that is initially designated as the PSAP to which the call will be routed to) is reached via Legacy SR.

When an SIP 488 Not Acceptable Here is received, the E-CSCF, which expects to receive a SIP 300 Multiple Choices message (per the current architecture), may act differently. The E-CSCF may send the SIP 488 Not Acceptable Here to the Caller's UE. According to 3GPP TS 24.229 specification, the caller's UE may then be expected to send a new SIP INVITE with the indicated media type when the UE receives a SIP: 488 Not Acceptable Here. The UE may notify the caller (the human user) about the modified call origination. As an alternative, the UE may wait for the caller (the human user) to initiate new call-origination steps.

In this approach, when the desired media type does not include Audio or Text, and the LRF returns a 488, embodiments of the present invention may improve the call handling-steps because the initial call setup request may not be sent all the way to the MGCF. Embodiments of the present invention may provide enhancements to ESRP/ECRF functions. An emergency call may be routed to the ESInet by the E-CSCF if the ES Route URI is in an SIP URI format without the user=phone. A TEL URI basically identifies a telephone number. A TEL URI can also be represented in an SIP URI format, with a user=phone. For example, a telephone number corresponding to TEL:+1561444555 is in TEL URI, and the same can be represented as SIP:+1561444555@carrier.net; user=phone. A SIP URI without the user=phone is used when the call has to be routed to a SIP destination. As such, if the ES Route URI contains a SIP URI without the user=phone, then the E-CSCF may conclude that the emergency call is to be routed to ESInet. From the ESInet, the call may be routed either to an NG9-1-1 PSAP or to a Legacy PSAP. Because call routing to a Legacy PSAP (via LPG or LSRG) may possibly occur, some enhancements may be required to address the MMES scenario. The enhancements may be similar to the LRF/RDF enhancements described above.

With a first enhancement to ESRP/ECRF functions, the ESRP may pass a MMES call attempt indication to the ECRF in a message (such as a LoST: findService message), if the desired media types indicate an MMES call attempt. Desired media types may be the media types that are present in the SDP of an SIP INVITE that is received from the originating IMS network. With a second enhancement to ESRP/ECRF functions, the ECRF may use this indication to select an NG9-1-1 PSAP (as an alternate PSAP, if available) in the event the first choice PSAP is a Legacy PSAP. With a third enhancement to ESRP/ECRF functions, the ESRP sends a SIP: 488 Not Acceptable Here to the originating IMS network if the desired media type indicated by the SIP INVITE does not have the media types supported by Legacy PSAP (i.e., the desired media type is different than audio or text), and if the destined PSAP is a Legacy PSAP. The SIP 488 Not Acceptable Here message may carry the supported SDP information and a warning header with the reason for the denial. With a fourth enhancement, the originating IMS network may take appropriate action upon receiving the SIP 488 Not Acceptable Here message. In embodiments of the present invention, the originating IMS network may forward the SIP 488 Not Acceptable Here message towards the UE.

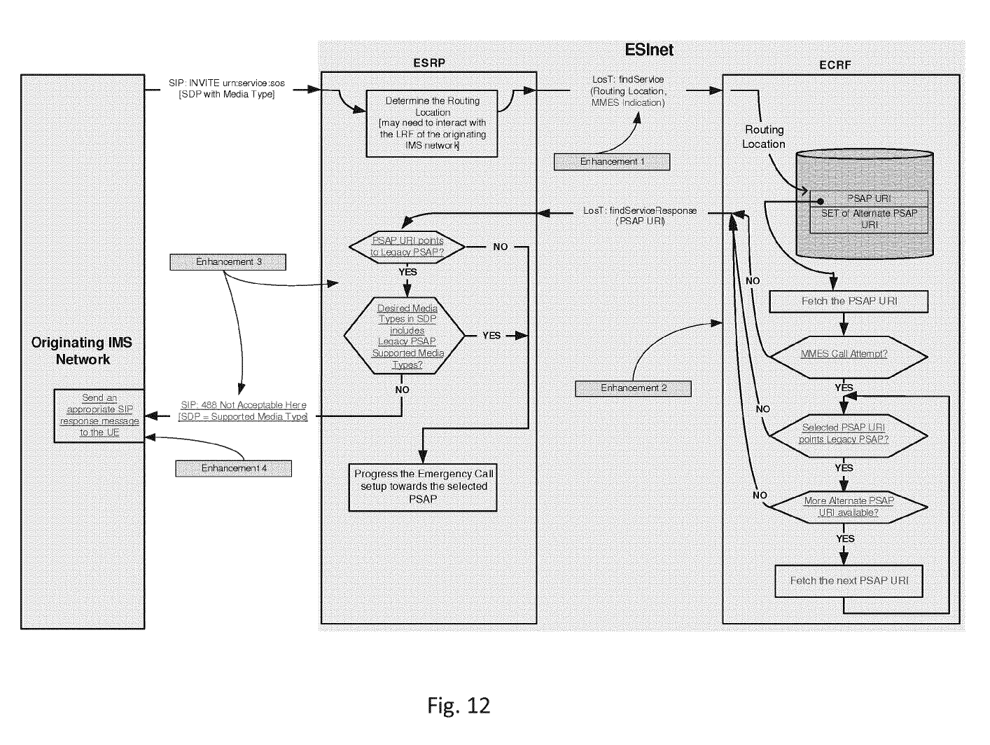

FIG. 12 illustrates enhancements to ESRP/ECRF functions. The first and second enhancements to ESRP/ECRF functions may be needed if a deployment selects an NG9-1-1 PSAP as an alternate PSAP that serves the caller's location, and if the emergency call is an MMES call, and if the first choice PSAP is a Legacy PSAP.

According to 3GPP TS 24.229 specification, the caller's UE is expected to send a new SIP INVITE with the indicated media type when the UE receives a SIP: 488 Not Acceptable Here. The UE may notify the caller (the human user) about the modified call origination. As an alternative, the UE may wait for the caller (the human user) to initiate the new call origination steps. With this approach, when the desired media type does not include Audio or Text, and with the ESRP returning the SIP 488 Not Acceptable Here message, embodiments of the present invention may improve the call handling steps because the initial call setup request may not be sent all the way to the nodes serving the Legacy PSAP (i.e., LPG or LSGR).

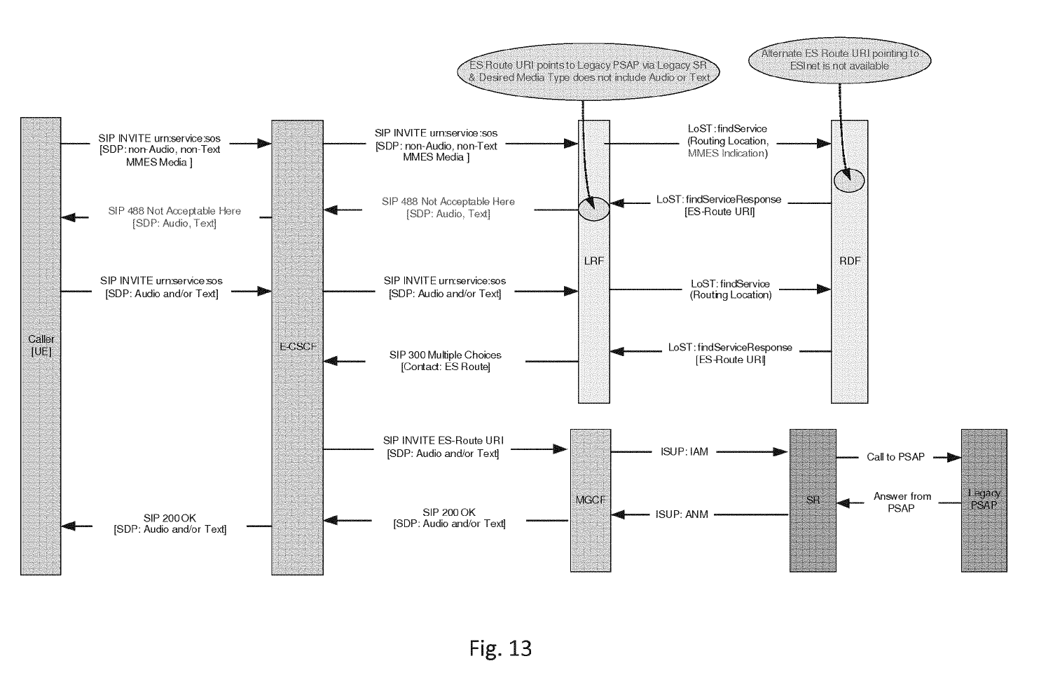

FIG. 13 illustrates a flow diagram that shows an MMES call origination attempt when the intended PSAP is to be via a Legacy SR, and the desired media is different from Audio or Text. Referring to FIG. 13, the caller originates an MMES call that includes media different from Audio or Text. As per the first enhancement to LRF/RDF functions, the LRF forwards the MMES Indication in the LoST: findService message to the RDF. The RDF determines that the designated PSAP (for which the call is to be routed to) is to be reached via Legacy SR, and the RDF utilizing the second enhancement is not able to find an alternate ES Route URI that would take the call to ESInet. The LRF, utilizing the third enhancement to LRF/RDF functions described above, returns a SIP 488 Not Acceptable Here to the E-CSCF with the supported media type indicating Audio and Text (because only those two media types can be supported for calls routed to a Legacy SR). The Caller's UE sends a new SIP INVITE with the media type of Audio and/or Text included in the SDP. The call is then routed to the Legacy PSAP via the Legacy SR as per the current Emergency call handling logic. As can be seen in FIG. 13, when the desired media type is different from Audio or Text, the initial call request is not routed all the way to the MGCF (as compared with FIG. 8).

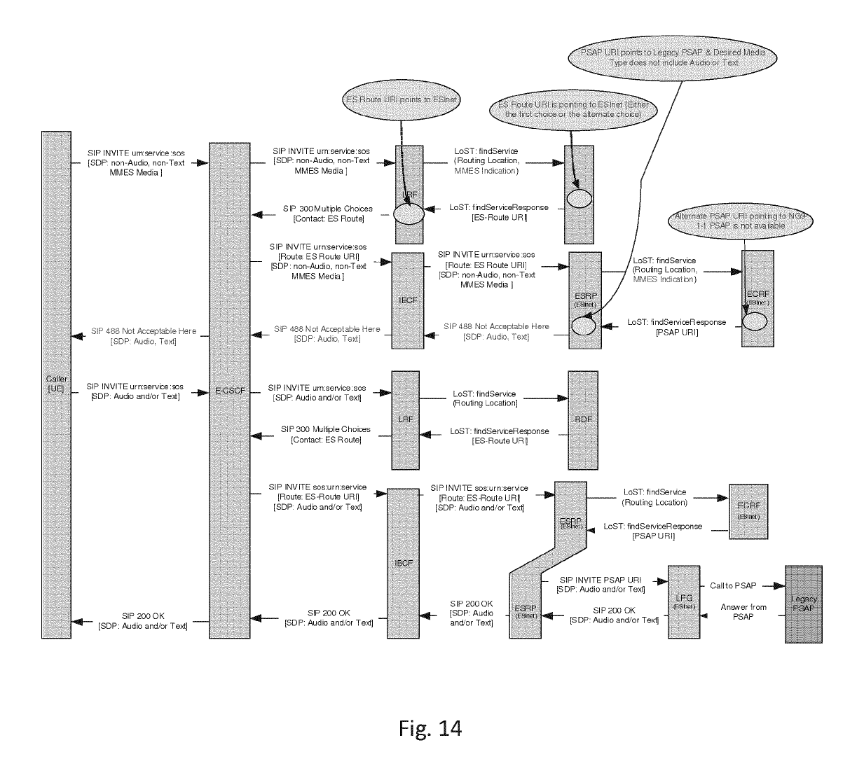

FIG. 14 illustrates a flow diagram that shows an MMES call origination attempt when the intended PSAP is a Legacy PSAP to be reached via ESInet, and the desired media is different from Audio or Text. Referring to FIG. 14, the caller originates an MMES call that includes media that is different from Audio or Text. As per the first enhancement to LRF/RDF functions, the LRF forwards the MMES Indication in the LoST: findService message to the RDF. The RDF finds the ES Route URI pointing to the ESInet (either as a first choice or after the RDF exercising the second enhancement to LRF/RDF functions finds an alternate ES Route URI that would take the call to ESInet). E-CSCF forwards the call to ESInet.

The ESRP, utilizing the first enhancement to ESRP/ECRF functions, forwards the MMES Indication in the LoST: findService message to the ECRF. The ECRF determines that a destination PSAP is Legacy PSAP (the ECRF utilizes the second enhancement), and the ECRF is not able to find an alternate PSAP URI pointing to an NG9-1-1 PSAP. The ESRP (that utilizes the third enhancement) returns a SIP 488 Not Acceptable Here to the originating IMS network (via IBCF to the E-CSCF) with the supported media type indicating Audio and Text (because only those two media types can be supported for calls routed to a Legacy PSAP).

The Caller's UE sends a new SIP INVITE with the media type of Audio and/or Text included in the SDP. If the first choice ES Route URI points to ESInet, the call is then routed to the Legacy PSAP via the ESInet (in this example, the call routed to the Legacy PSAP via LPG) as per the current Emergency call handling logic. As illustrated by FIG. 14, when the desired media type includes media different than Audio or Text, the initial call request is not routed all the way to the LPG.

Embodiments of the present invention can handle all emergency calls. According to certain embodiments of the present invention, when the caller originates a normal (non-MMES) emergency call, the flow diagram may follow the previous approaches. For example, a non-MMES call attempt that is to be directed to a Legacy PSAP via Legacy SR follows the flow diagram shown in FIG. 3. Because the emergency call is a non-MMES call, the LRF does not set the MMES indication in the LoST: findService message. Because the MMES indication is not set, the RDF returns the ES Route URI without bothering to look at the alternate ES Route URI, upon discovering that the first choice ES Route URI would take the call to a Legacy PSAP via Legacy SR. Because the desired media type is non-MMES, the LRF returns a SIP 300 Multiple Choices, and the call is completed to the Legacy PSAP via Legacy SR.

When the caller originates a normal (non MMES) emergency call, the flow diagram follows the previous approaches. For example, a non-MMES call attempt that is to be directed to a Legacy PSAP via ESInet follows the flow diagram of FIG. 6. Because the emergency call is a non-MMES call, the LRF does not set the MMES indication in the LoST: findService message. In this example, because the MMES indication is not set, the RDF would not have made any attempt to look for an ES Route URI that points to the ESInet. Therefore, in this example, the first choice ES Route URI happens to point to the ESInet.

The ESRP, in the ESInet, does not set the MMES indication in the LoST: findService message because the desired media type is non-MMES. Because the MMES indication is not set, the ECRF does not bother to look for a NG9-1-1 PSAP upon discovering that the first choice PSAP is Legacy PSAP. The ESRP completes the emergency call to the Legacy PSAP via LPG or LSRG. When the caller originates a normal (a non-MMES) emergency call, the flow diagram follows the previous approaches. For example, a non-MMES call attempt that is to be directed to an NG9-1-1 PSAP follows the flow diagram shown in FIG. 5. Because the emergency call is a non-MMES call, the LRF does not set the MMES indication in the LoST: findService message. In this example, because the MMES indication is not set, the RDF would not have made any attempt to look for an ES Route URI pointing to the ESInet. Therefore, in this example, the first choice ES Route URI happens to point to the ESInet.

The ESRP, in the ESInet, does not set the MMES indication in the LoST: findService message because the desired media type is non-MMES. Because the MMES indication is not set, the ECRF would not have bothered to look for PSAP URI pointing to an NG9-1-1 PSAP. Therefore, in this example, the first choice PSAP URI happens to point to a NG9-1-1 PSAP. The ESRP completes the emergency call to the NG9-1-1 PSAP.

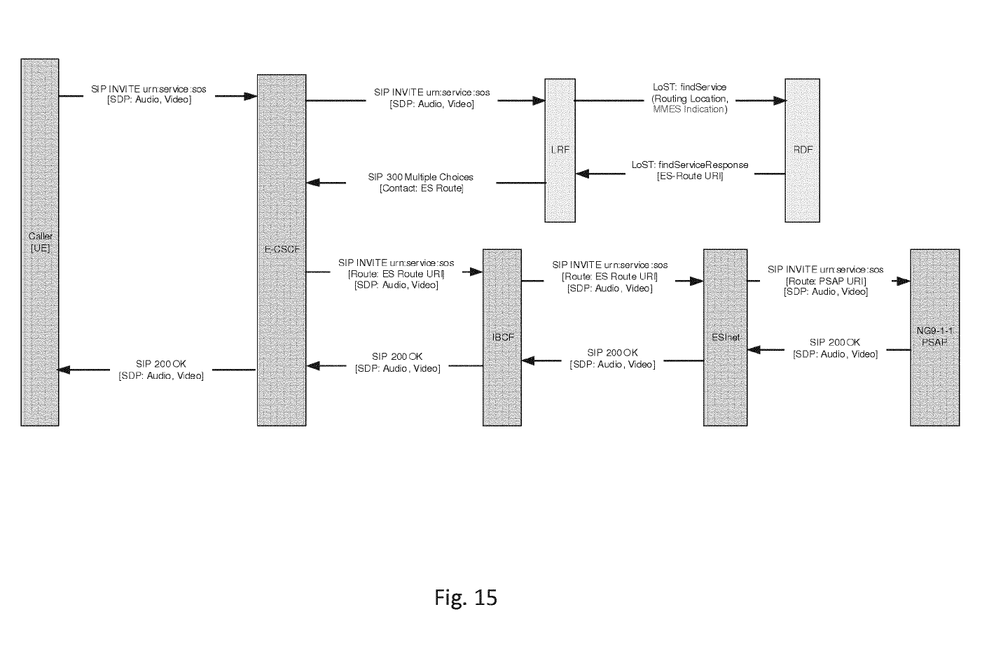

When the caller originates an MMES call where NG9-1-1 happens to be the destination PSAP, the flow diagram of FIG. 15 will be applicable. In FIG. 15, the caller originates an MMES call (where the MMES call may include audio and video). The LRF sets the MMES Indication in the LoST: findService message. The RDF finds that the ES Route URI points to ESInet. This may be the first-choice ES Route URI. Alternatively, the RDF, according to embodiments of the present invention, may find an alternate ES Route URI pointing to the ESInet. The LRF sends the SIP 300 Multiple Choices to the E-CSCF because the ES Route URI points to the ESInet. Even otherwise, the LRF would have returned a SIP 300 Multiple Choices to the E-CSCF because the desired media type includes Audio. The E-CSCF sends the SIP INVITE with audio and video to the ESInet. The ESRP in the ESInet (not shown) sets the MMES indication in the Lost: findService message. The ECRF (not shown) finds that the PSAP URI points to a NG9-1-1 PSAP (either as a first choice or as an alternative choice after applying embodiments of the present invention). The ESRP (not shown separately) completes the MMES call to the NG9-1-1 PSAP.

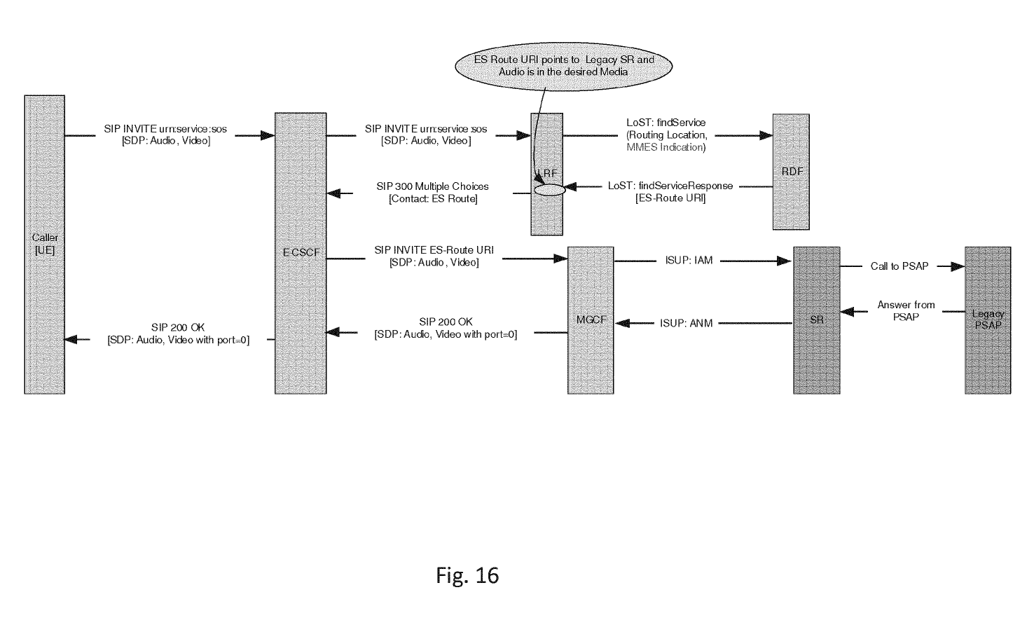

FIG. 16 illustrates a flow diagram that shows the MMES call origination attempt when the intended PSAP is served via Legacy SR and the desired media includes Audio (the call can also include Text). In FIG. 16, the caller originates an MMES call attempt (where the MMES call includes audio and video). The LRF sets the MMES Indication in the LoST: findService message. The RDF finds that the ES Route URI points to the Legacy SR (the RDF is not able to find an alternate ES Route URI pointing to ESInet). The LRF sends the SIP 300 Multiple Choices to the E-CSCF because the desired media type includes Audio. The E-CSCF sends the SIP INVITE with audio and video as the desired media types towards the Legacy SR. The MGCF sets up the call to Legacy PSAP, but returns a port=0 for the video in the SDP Answer (in the example, SDP Answer comes in SIP 200 OK). At the end, the call is established as a non-MMES call.

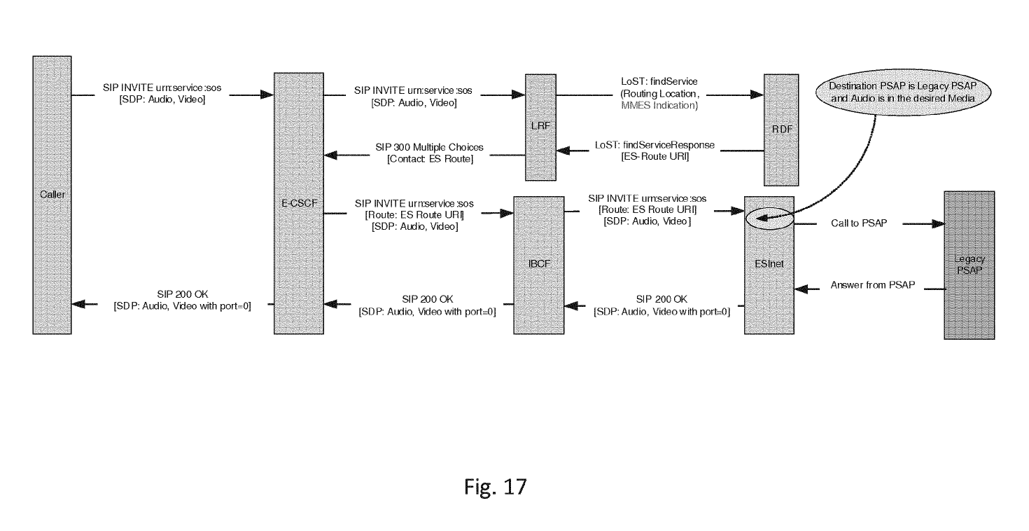

FIG. 17 illustrates a flow diagram that shows the MMES call origination attempt when the intended PSAP is served via Legacy PSAP via ESInet, and the desired media may include Audio (the desired media may also include Text). Referring to FIG. 17, the caller originates an MMES call attempt (where the call includes both audio and video). The LRF sets the MMES Indication in the LoST: findService message. The RDF finds that the ES Route URI points to ESInet (either as a first choice or as an alternate choice). The LRF sends the SIP 300 Multiple Choices to the E-CSCF since the desired media type includes Audio (also the ES Route URI points to ESInet). The E-CSCF sends the SIP INVITE (with audio and video as the desired media types) towards the ESInet. The ESRP sets the MMES indication in the LoST: findService message sent to the ECRF (the ESRP and ECRF are not shown in FIG. 17). The ECRF returns the PSAP URI pointing to the Legacy PSAP in LoST: findServiceResponse message to the ESRP. The ECRF is not able to find an NG9-1-1 PSAP that serves the caller's location. ESRP forwards the call towards the Legacy PSAP because audio is one of the desired media types. The call sets up the Legacy PSAP. The node serving the Legacy PSAP (LPG or LSRG) returns a port=0 for the video in the SDP Answer (in the example, SDP Answer comes in SIP 200 OK). At the end, the call is established as a non-MMES call to the Legacy PSAP.

In an alternative embodiment, the RDF may maintain within the database media supported by each ES Route URI. The RDF may return the supported media in the LoST: findServiceResponse message to the LRF. The LRF can check to determine if at least one of the desired media types is supported by the ES Route URI. If none of the desired media types are not supported by the ES Route URI, the LRF could return a SIP: 488 Not Acceptable Here message to the E-CSCF.

The LRF in LoST: findService could pass all the desired Media Types to the RDF. The RDF, while selecting the alternate ES Route URI, may use all the desired media type to determine a best match to the supported media types.

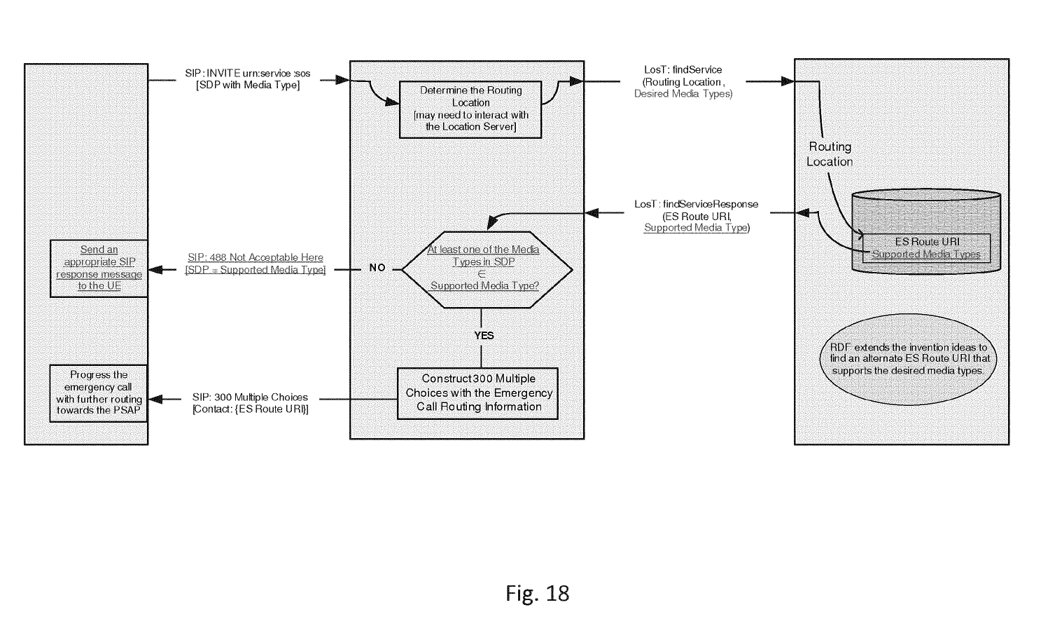

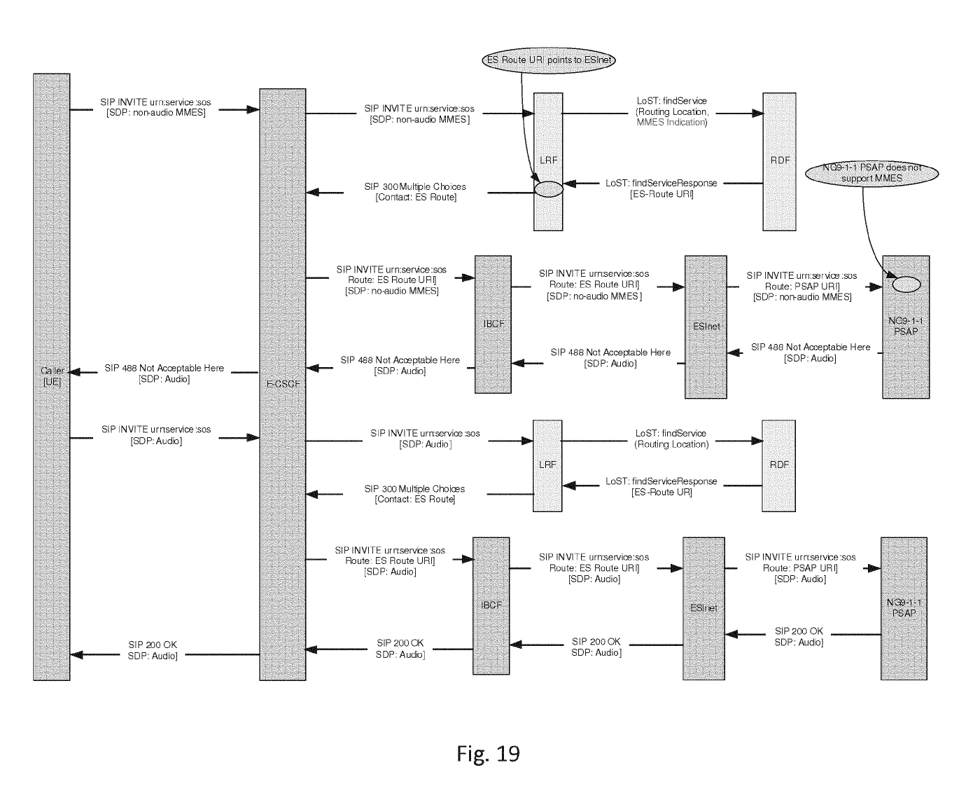

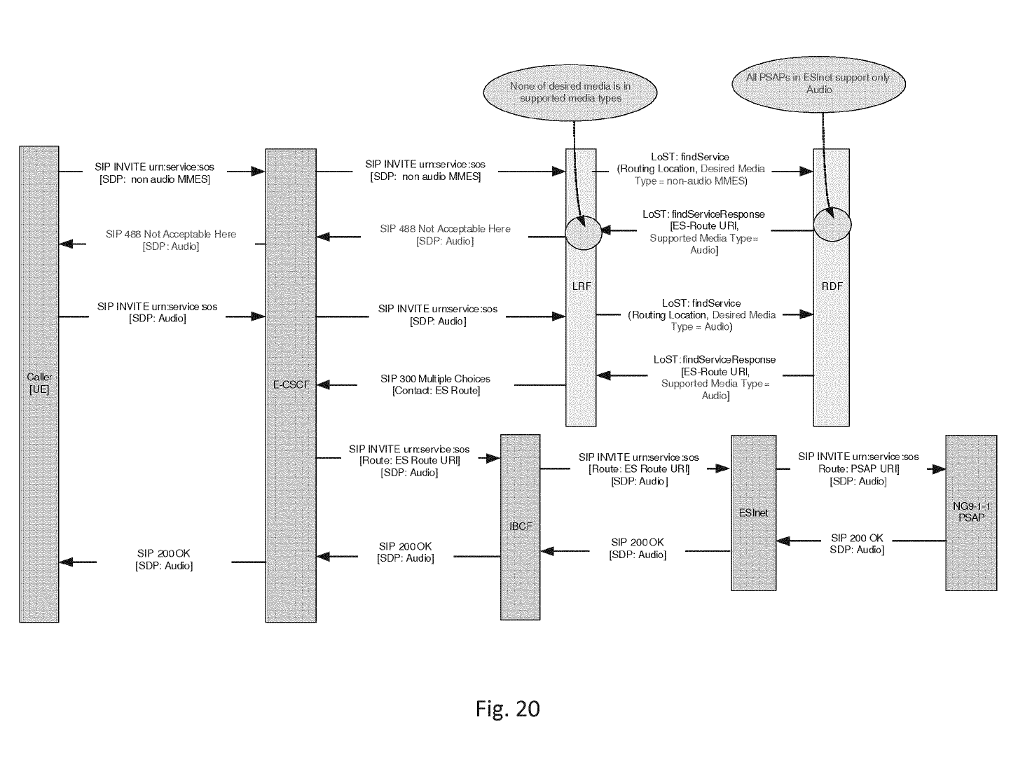

FIG. 18 illustrates an alternative implementation in accordance with one embodiment. This alternative implementation may be useful if the MMES is not deployed in certain Emergency Services network (i.e., even if the destined PSAP is a NG9-1-1 PSAP). Alternatively, even though calls are routed to an ESInet, in a particular deployment, NG9-1-1 PSAPs may not exist (in other words, all calls go to the Legacy PSAP via ESInet). Maintaining the supported media types against the ES Route URI will reduce the signalling load as the call will not be routed to ESInet if none of the desired media is supported by the ESInet. For example, FIGS. 19 and 20 illustrate an advantage of this alternate implementation idea.

FIG. 19 illustrates an embodiment of the present invention. FIG. 20 illustrates a same use-case with an alternative implementation of the present invention. In FIG. 19, the LRF sets the MMES indication because the desired media type is MMES. ES Route URI points to the ESInet, and, therefore, the LRF returns SIP 300 Multiple Choices message to the E-CSCF. The E-CSCF forwards the call towards ESInet. In ESInet, the ECRF finds that the PSAP URI points to a NG9-1-1 PSAP and, hence, routes the call to the NG9-1-1 PSAP. If the NG9-1-1 PSAP is not equipped to support the multimedia, the NG9-1-1 PSAP has no choice but to return a SIP 488 Not Acceptable Here with Audio as the Supported Media, for example. The UE, upon receiving the SIP 488 Not Acceptable Here, sends the SIP INVITE with the desired media type set to Audio. The call gets completed at NG9-1-1 as a non-MMES call.

FIG. 20 illustrates another embodiment of the present invention. In FIG. 20, an alternative implementation is illustrated. The LRF passes the non-audio MMES media types present in the SDP of SIP INVITE as the desired media types in the LoST: findService message. As previously described, this enhancement may be needed only if a deployment wants to use the finding of an alternate ES Route URI that serves the caller's location. The RDF returns Audio as the Supported Media in the LoST: findServiceResponse message. The LRF finds out that none of the desired media types (because audio is not a desired media type) are supported by the ES Route URI. Hence, the LRF would return a SIP: 488 Not Acceptable Here to the E-CSCF with Audio as the Supported Media. The UE then sends a new SIP INVITE with Audio as the desired media type, and the call gets completed.

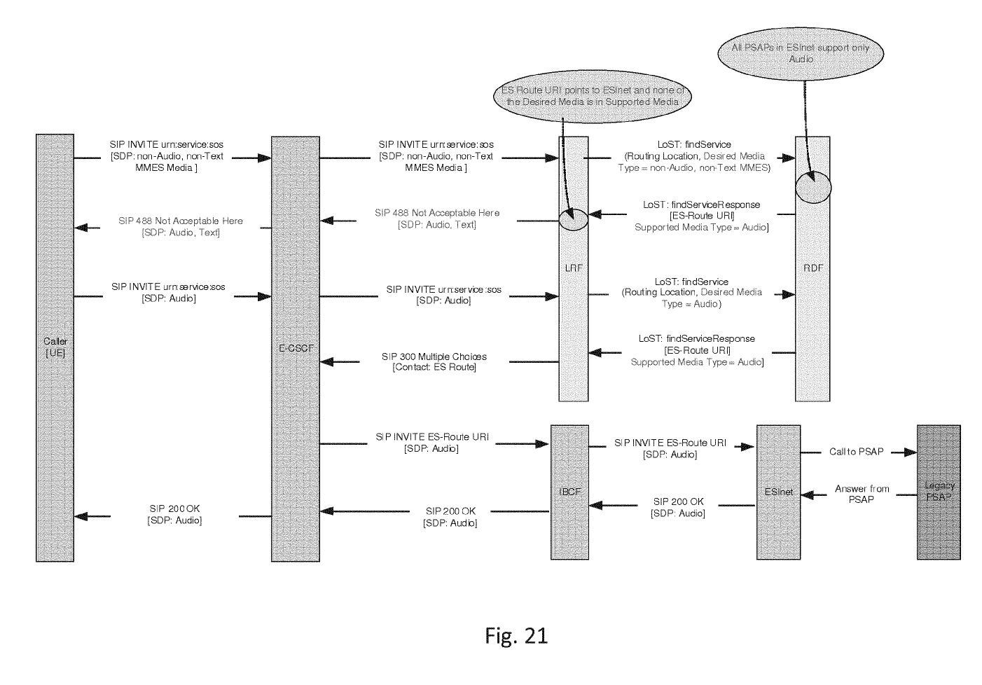

Another use-case, as previously described, is that NG9-1-1 PSAPs are not deployed, but ESInet is deployed. In this case, the emergency calls routed towards ESInet end up at the Legacy PSAP via LPG or LSRG. When a caller makes an MMES call (without audio or text), the call setup follows the flow diagram shown in FIG. 14. With the alternative implementation, the flow-diagram shown in FIG. 21 may be replaced by the flow diagram shown in FIG. 14.

FIG. 21 illustrates an MMES Call Attempt to Legacy PSAP via ESINET. In FIG. 21, an alternative implementation idea is applied. The LRF passes the non-audio, non-text MMES media types present in the SDP of SIP INVITE as the desired media types in the LoST: findService message. As previously described, this enhancement may be needed only if a deployment wants to use the findings of an alternate ES Route URI that serves the caller's location. The RDF returns audio as the Supported Media in the LoST: findServiceResponse message. The LRF finds out that none of the desired media types are supported by the ES Route URI. Hence, the LRF would return a SIP: 488 Not Acceptable Here to the E-CSCF with Audio as the Supported Media. The UE then sends a new SIP INVITE with Audio as the desired media type and the call gets completed. The flow in FIG. 21 is simpler than the flow in FIG. 14. This alternative implementation requires changes to RDF and the LoST protocol in order to add the Supported Media Type.

This alternative implementation may be useful for the following use-cases. The alternative implementation may be useful for when an NG9-1-1 PSAP does not support MMES, and the caller makes an emergency call without the audio or text being included as the desired media type. The alternative implementation may also be useful for when NG9-1-1 PSAPs are not deployed, but ESInet is deployed. All calls from ESInet go to a Legacy PSAP. In yet another embodiment, the RDF may maintain an indication of whether or not MMES is supported by PSAPs connected to the ESInet. This will address the same use-cases as mentioned above and may be simpler to implement.

The LRF may have different rules. Instead of checking to determine whether Audio or Text is included in the desired media type, when the call is to be routed to Legacy SR, the LRF could send a SIP 488 Not Acceptable Here for all MMES call types when ES Route URI directs to the Legacy SR. With this approach, the downgrading of an MMES call to a non-MMES emergency call is initiated by the UE. Furthermore, the approach will not be dependent on the capabilities of an MGCF. Sending a SIP 488 Not Acceptable Here for all cases of MMES will make calls go through LRF/RDF twice.

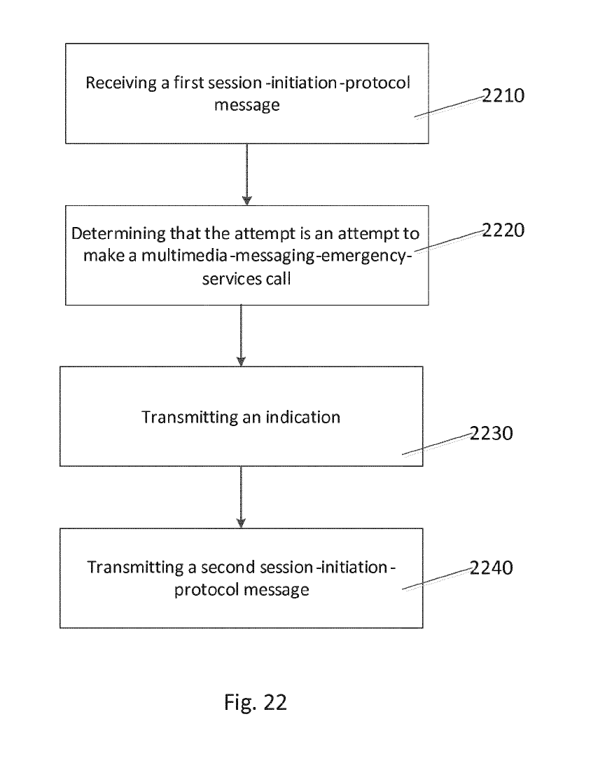

FIG. 22 illustrates a logic flow diagram of a method according to certain embodiments of the invention. The method illustrated in FIG. 22 may comprise, at 2210, receiving, by a first network node, a first session-initiation-protocol message relating to an attempt to make a call. The method may also include, at 2220, determining that the attempt to make the call is an attempt to make a multimedia-messaging-emergency-services call. The method may also include, at 2230, transmitting an indication of the attempt to make the multimedia-messaging-emergency-services call. The indication is transmitted to a second node. The method may also include, at 2240, transmitting a second session-initiation-protocol message relating to a denial of serving the multimedia-messaging-emergency-services call.

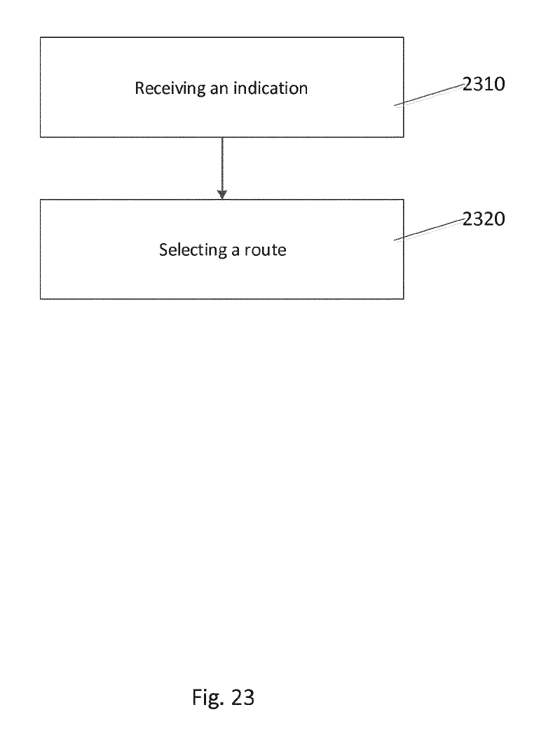

FIG. 23 illustrates a logic flow diagram of a method according to certain embodiments of the invention. The method illustrated in FIG. 23 may comprise, at 2310, receiving, by a network node, an indication of an attempt to make a multimedia-messaging-emergency-services call. The method may also include, at 2320, selecting a route that would redirect the multimedia-messaging-emergency-services call.

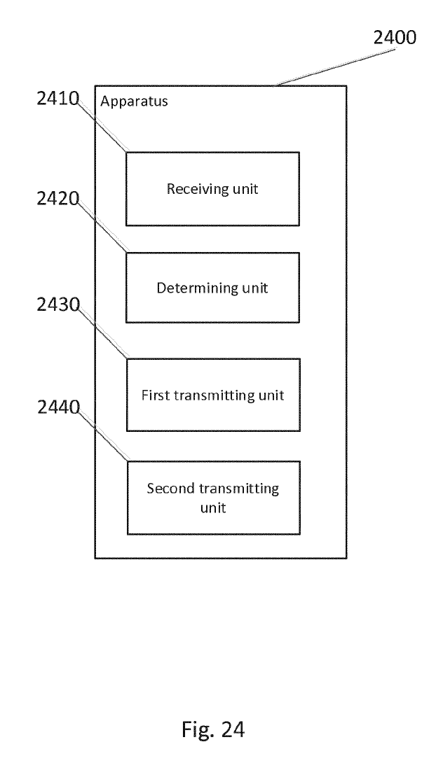

FIG. 24 illustrates an apparatus in accordance with one embodiment. Apparatus 2400 may comprise a receiving unit 2410 that receives a first session-initiation-protocol message relating to an attempt to make a call. Apparatus 2400 includes a determining unit 2420 that determines the attempt to make the call is an attempt to make a multimedia-messaging-emergency-services call. Apparatus 2400 includes a first transmitting unit 2430 that transmits an indication of the attempt to make the multimedia-messaging-emergency-services call. The indication is transmitted to a second node. Apparatus 2400 includes a second transmitting unit 2440 that transmits a second session-initiation-protocol message relating to a denial of serving the multimedia-messaging-emergency-services call.

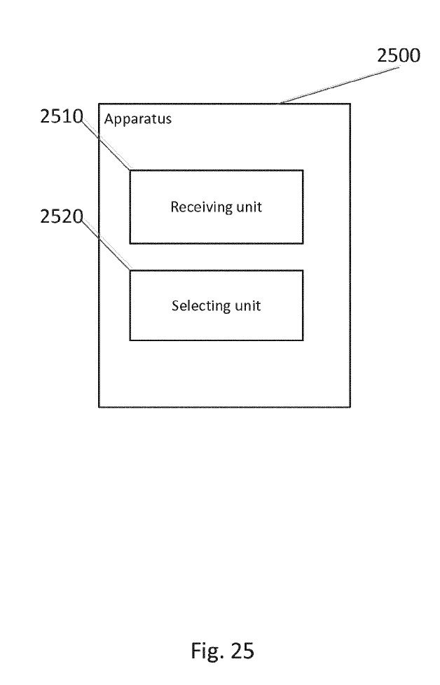

FIG. 25 illustrates an apparatus in accordance with one embodiment. Apparatus 2500 may comprise a receiving unit 2510 that receives an indication of an attempt to make a multimedia-messaging-emergency-services call. Apparatus 2500 may also comprise a selecting unit 2520 that selects a route that would redirect the multimedia-messaging-emergency-services call.

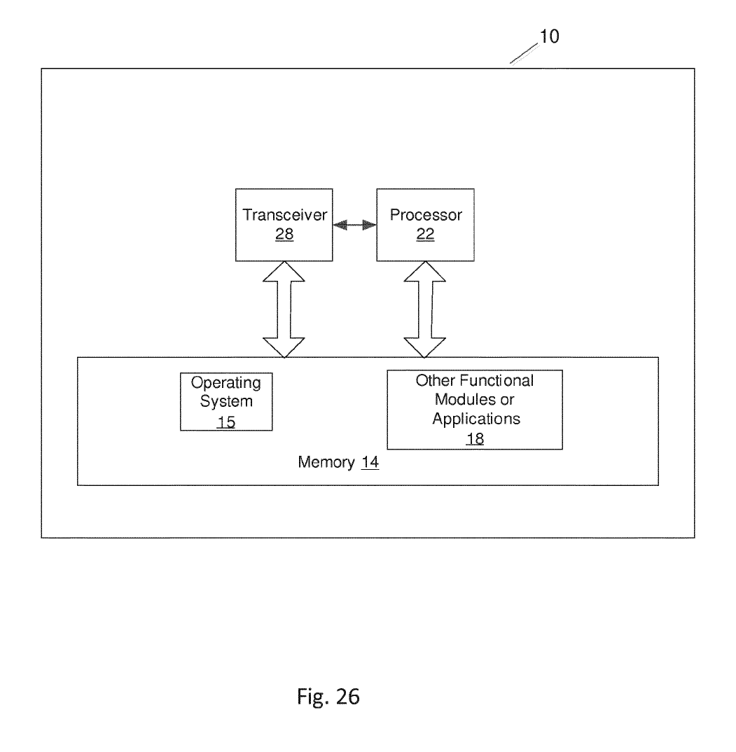

FIG. 26 illustrates an apparatus 10 according to embodiments of the invention. Apparatus 10 can be a device, such as a UE, for example. In other embodiments, apparatus 10 can be a location-retrieval function, a routing-determination function, an emergency-services-routing-proxy, and/or an emergency-call-routing-function, for example.

Apparatus 10 can comprise a processor 22 for processing information and executing instructions or operations. Processor 22 can be any type of general or specific purpose processor. While a single processor 22 is shown in FIG. 26, multiple processors can be utilized according to other embodiments. Processor 22 can also comprise one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further comprise a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 can comprise program instructions or computer program code that, when executed by processor 22, enable the apparatus 10 to perform tasks as described herein.

Apparatus 10 can also comprise one or more antennas (not shown) for transmitting and receiving signals and/or data to and from apparatus 10. Apparatus 10 can further comprise a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 comprising, without limitation, precoding of antenna gain/phase parameters, encoding and decoding of individual bits forming a communication message, formatting of information, and overall control of the apparatus 10, comprising processes related to management of communication resources.

In certain embodiments, memory 14 stores software modules that provide functionality when executed by processor 22. The modules can comprise an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
receiving, by a first network node, a first session-initiation-protocol message relating to an attempt to make a call;
determining that the attempt to make the call is an attempt to make a multimedia-messaging-emergency-services call;
transmitting an indication of the attempt to make the multimedia-messaging-emergency-services call, wherein the indication is transmitted to a second node; and
transmitting a second session-initiation-protocol message relating to a denial of serving the multimedia-messaging-emergency-services call.

2. The method according to claim 1, wherein the first network node comprises a location-retrieval-function, and the second node comprises a route-determination-function.

3. The method according to claim 1, wherein the first network node comprises an emergency-services-routing-proxy, and the second node comprises an emergency-call-routing-function.

4. (canceled)

5. (canceled)

6. The method according to claim 1, wherein the transmitting the indication of the attempt comprises transmitting the indication via a LoST:findService message.

7. An apparatus, comprising:
receiving means for receiving a first session-initiation-protocol message relating to an attempt to make a call;
determining means for determining that the attempt to make the call is an attempt to make a multimedia-messaging-emergency-services call;
first transmitting means for transmitting an indication of the attempt to make the multimedia-messaging-emergency-services call, wherein the indication is transmitted to a first node; and
second transmitting means for transmitting a second session-initiation-protocol message relating to a denial of serving the multimedia-messaging-emergency-services call.

8. The apparatus according to claim 7, wherein the apparatus comprises a location-retrieval-function, and the first node comprises a route-determination-function.

9. The apparatus according to claim 7, wherein the apparatus comprises an emergency-services-routing-proxy, and the first node comprises an emergency-call-routing-function.

10. (canceled)

11. (canceled)

12. The apparatus according to claim 7, wherein the transmitting the indication of the attempt comprises transmitting the indication via a LoST:findService message.

13. (canceled)

14. A method, comprising:
receiving, by a network node, an indication of an attempt to make a multimedia-messaging-emergency-services call; and
selecting a route that would redirect the multimedia-messaging-emergency-services call.

15. The method according to claim 14, wherein the network node comprises a routing-determination-function.

16. The method according to claim 14, wherein the network node comprises an emergency-call-routing-function.

17. The method according to claim 14, wherein the selecting the route comprises selecting an alternate emergency-services route uniform-resource-identifier.

18. The method according to claim 14, wherein the selecting the route comprises selecting a route that redirects the multimedia-message-emergency-services call away from a legacy public-safety-answering point.

19. The method according to claim 14, wherein the selecting the route comprises selecting a route that takes the multimedia-message-emergency-services call to an emergency-services-ip-network.

20. An apparatus, comprising:
receiving means for receiving an indication of an attempt to make a multimedia-messaging-emergency-services call; and
selecting means for selecting a route that would redirect the multimedia-messaging-emergency-services call.

21. The apparatus according to claim 20, wherein the apparatus comprises a routing-determination-function.

22. The apparatus according to claim 20, wherein the apparatus comprises an emergency-call-routing-function.

23. The apparatus according to claim 20, wherein the selecting the route comprises selecting an alternate emergency-services route uniform-resource-identifier.

24. The apparatus according to claim 20, wherein the selecting the route comprises selecting a route that redirects the multimedia-message-emergency-services call away from a legacy public-safety-answering point.

25. The apparatus according to claim 20, wherein the selecting the route comprises selecting a route that takes the multimedia-message-emergency-services call to an emergency-services-ip-network.

26. (canceled)
